(19) United States
(12) Patent Application Publication
(10) Pub. No.: US 2016/0227745 A1
(43) Pub. Date: Aug. 11, 2016

(54) BEEHIVE SYSTEM

(71) Applicant: Roland O. Reed, Sneads Ferry, NC (US)

(72) Inventor: Roland O. Reed, Sneads Ferry, NC (US)

(21) Appl. No.: 14/617,414

(22) Filed: Feb. 9, 2015

(51) Int. Cl. A01K 47/02; A01K 47/06

(52) U.S. Cl. CPC A01K 47/02; A01K 47/06

(57) ABSTRACT

The present invention relates to a design for a beehive comprising partial multi-story construction with features of a top bar hive to produce more honey without the known problems associated with stacked hives or top bar hives.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to a beehive and the components for raising honeybees and extracting honey where excess exists.

2. Description of Related Art

The raising of bees for honey has existed for literally thousands of years. The vast majority of commercial beekeepers today use a system comprising a super with removable frames, wherein each frame is spaced from one another by a “bee space”, which is the proper space for bees to optimally use the frames. The frame types are usually stacked supers in appearance, with each super having the same length and width, though some configurations use a shallower super for the top super. Traditional frame type hives consist of ten frames per super, per level. While these types of frames generally produce vast amounts of honey, they are considered difficult to lift because they are heavier than other types, have problems in use in terms of both time and equipment, and are considered to be environmentally difficult to bee populations.

A second type of hive is the top bar hive, which is generally a type of hive with no solid frames and one story. Top bar hives generally have a single bar that honeycombs hang from. They contain no rectangular frames. Amateurs have adopted the top bar type of hives because they are generally considered easier to handle and considered more environmentally friendly and sustainable for the bee population. Because the top bar hives are not as productive as commercial stacked hives, amateurs often quit out of frustration with low honey production coupled with a lack of proper instructions. Honeycombs can easily break off of a single bar due to weight and lack of support. Beekeeping is still an area where a more productive hive configuration is more desirable than a conventional top bar hive, and a combination is needed in the industry.

### BRIEF SUMMARY OF THE INVENTION

The present invention relates to the discovery that a hybrid beehive, having some of the features of both top bar hives and stacked beehives in a unique arrangement, allows for increased honey production while advantageously keeping the benefits of the top bar hive. The present invention, in one embodiment, comprises the equivalent of two side-by-side standard beehive bottom boards, with an extra long hive body placed lengthwise across the two bottom boards and spanning the entire width of the two bottom boards.

Accordingly, in one embodiment, there is a beehive system comprising:
a) a pair of rectangular beehive bottom boards each having the same length and width as each other, the bottom boards having raised sides along their lengths and a first width, the bottom boards positioned side by side along their lengths wherein the side by side lengths have at least a portion of their height lower than the height of the opposite sides of each bottom board, such that a bee can travel between bottom boards when a hive body is positioned thereon, and wherein each bottom board has a bee entrance on a second width facing the same direction;
b) a rectangular hive body having perpendicular sides relative to a bottom and having a length adapted to fit the width of the side by side bottom boards, the hive body positioned on the pair of bottom boards across the two widths, the hive body adapted to receive rectangular beehive frames;
c) a honey super positioned over the hive body and over one of the bottom boards;
d) an outer cover to fit the top of the honey super; and
e) a migratory cover to fit the top of the hive body over the portion of the hive body not covered by a honey super.

And, in another embodiment, there is a rectangular hive body of a size having perpendicular sides relative to a bottom and having a length adapted to fit on at least the width of two side by side beehive bottom boards.

And, in another embodiment, there is a rectangular beehive bottom board, the bottom board having raised sides along its lengths and a first width, and having at least a portion of one of the long sides lower than the height of the opposite side of the bottom board, such that a bee can travel between the bottom boards and the bottom of a hive body when a hive body is positioned thereon.

In another embodiment, there is a beehive system comprising:
a) a frame honey super having a first length and a first width;
b) a beehive bottom board having a second width larger than the honey super first width wherein bees can travel the entire widths of the bottom boards;
c) a hive body the width and length of the beehive bottom board having perpendicular sides adapted to receive rectangular beehive frames the body position on the bottom board; and
d) wherein the honey super is positioned on a portion of the hive body and wherein the bottom board has a bee entrance.

In another embodiment, there is a frame for use in a beehive accepting rectangular frames comprising a top bar, two upright side bars, and a bottom bar wherein the top bar is longer than the bottom bar.

In another embodiment, there is a beehive bottom board for use with a beehive super by a first width and first length comprising the bottom board the same length as the super and having a width wider than the super by at least about 10%, wherein bees can travel essentially the entire width of a bottom of the board.

### BRIEF DESCRIPTION OF THE DRAWINGS

FIG. 1 is a perspective view of the beehive system of the present invention.

FIG. 2 is a perspective of a base frame of the beehive.

FIG. 3 is a perspective view of a beehive bottom board on the base.

FIG. 4 is a perspective of a screen positioned on the bottom boards.

FIG. 5 is a perspective view of two bottom boards positioned side-by-side along their length.

FIG. 6 is a perspective view of the hive body positioned across the width of the two bottom boards.

FIG. 7 is a perspective of the back wall of the hive body showing a viewing window.

FIG. 8 shows an outer cover spanning the length of the hive body.

FIG. 9 is a perspective view of an outer cover on the honey super and an inner cover on the hive body not covered by the honey super.

FIG. 10 is a perspective view of beehive frames, feeders, and dividers in a hive body.

FIG. 11 is a perspective of a extra wide bottom board with a single bee entrance.

FIG. 12 is a perspective view of a view frame of the present invention and a beehive divider board.

### DETAILED DESCRIPTION OF THE INVENTION

While this invention is susceptible to embodiment in many different forms, there is shown in the drawings, and will herein be described in detail, specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting” or “consisting of” claim language and is so intended.

References throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitations thereto. The term “means” preceding a present participle of an operation indicates a desired function for which there is one or more embodiments, i.e., one or more methods, devices, or apparatuses for achieving the desired function, and that one skilled in the art could select from these or their equivalent in view of the disclosure herein and use of the term “means” is not intended to be limiting.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

As used herein the term “beehive system” refers to an artificial enclosure made for the purpose of raising honey bees in order to produce honey, as well as increase the neighboring honey bee population for the purpose of local plant fertilization. Typical systems are made from cypress, but can be made of any suitable hive material. The present invention relates to hybrid top hive/partial multistory type hive systems which, unlike regular top hives, have artificial rectangular hive frames and, unlike full multistory hives, are more ecologically productive for bees and only partially multistory. Beehive frames are standard frames that are normally utilized in multistory hives and are readily available and standardized in size. These standardized multistory enclosures, both for the main hive and the upper stories or supers, hold 8 to 10 frames commercially, though any size is contemplated, with enough room for the bees in between. Frames are for the purpose of honeycomb, where the bees can deposit eggs, brood, pollen, sugar supplements, honey, food, and the like, or where the beekeeper can manipulate or feed the bee colony. In one embodiment, frames are coded, in one embodiment on the top bar, to indicate function, contents or manipulations of the frames, e.g. queen rearing, drone traps, varroa mites, viewing frames, year of comb replacement, etc. In one embodiment, the coding is color coding, but any identifying marks could be utilized.

As used herein, the term “beehive bottom boards” in one embodiment refers to standard bottom boards used underneath the bottom hive enclosure in multistory beehives. Standard size is about 19 13/16″×16¼″ for holding 8 to 10 frames. They match the length and width of the frame containers, such as the standard 8 to 10 frame supers. Normal or standardized beehive bottom boards have a raised side on the two short sides and along the back width, and no raised sides on the front width, where the bees enter frequently through entrance reducers. The entrance reducers utilized are standardized. The drawings depict the standardized bottom boards, which have been novelly modified on one long edge, such that, as seen in the drawings, when the edges are reduced in height and placed side by side, there is a space or channel for bees to pass from one bottom board to the other. Without these lower sides (compared to the opposite sides) bees could not pass. In one embodiment, the lower side is only a portion of one of the long sides. In practice, there will be lower sides on one right side of a board and a matching one with a lower side on the left side, as seen in the drawings.

A novel bottom board of the present invention, in another embodiment, relates to a bottom board that is wider than the standard bottom boards. The bottom board will be wider than the honey super used in the system, but essentially the same length. In one embodiment, it is about twice as wide, but can be as wide as desired as long as it is wider than the super's width used with it in the present invention (see Figures). In one embodiment, it is about 20″ to about 30″, 25″ to 40″, 30″ to 35″, and in another about 32½″ wide. The board will have raised sides on the two short sides (length) and along the back width with no raised side on the front width, where bees can enter through one or more entrance reducers. The bottom board has a bottom surface which allows bees to move along the whole width of the bottom board, like the double bottom boards.

As used herein, the term “hive body” refers to a rectangular enclosure with an open top, a device for holding standard sized hive frames (as known in the art), and a length that fits across the width of the two bottom boards, or the novel wide bottom board, as shown in the drawings. When the hive body is two standard enclosures wide, it will hold, in one embodiment, about 20 to 22 frames if on two bottom boards or one novel bottom board. It can also have a window in the back width for viewing, as seen in the drawings.

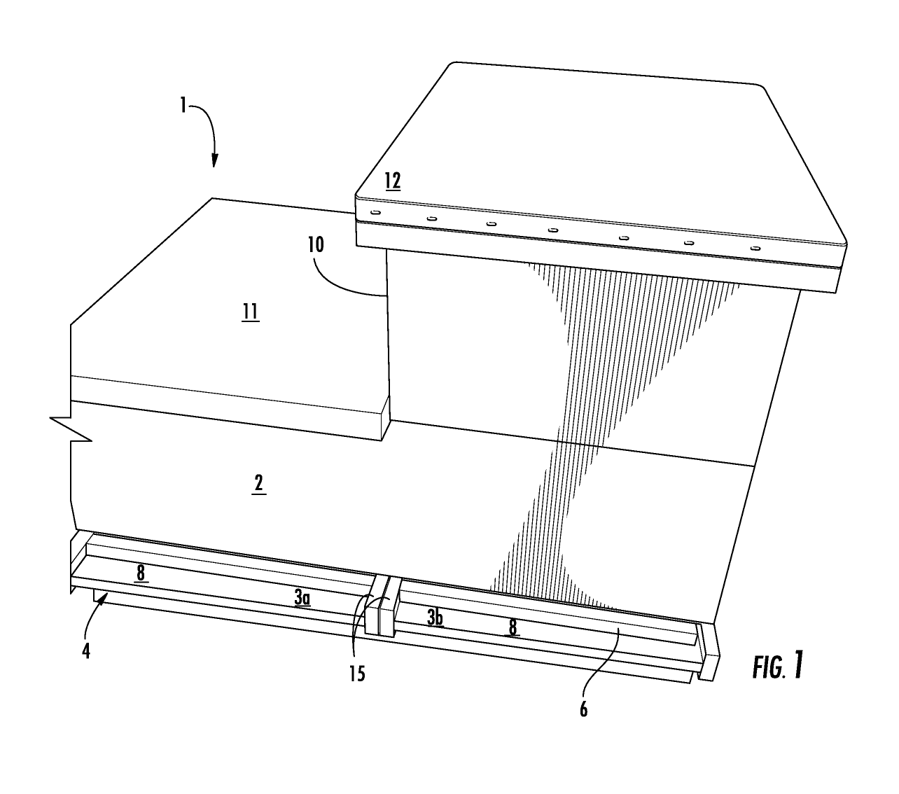

As used herein, the term “honey super” refers to another hive frame holding a device the basic length and width of a multistory hive (i.e. just a bit shorter than one bottom board and the width of one bottom board), and supers are 19 13/16″ by 16¼″. These are standard in the industry and typically hold ten frames, but have never been utilized with a hive enclosure wider or double the width of the super, as utilized herein, as shown in the drawings, especially FIG. 1. In one embodiment, there can be multiple honey supers, as in a standard multistory beehive stacked on one another (and not side by side). The resulting device is multistory on only half of the beehive, and a single story on the other half of the beehive. There are then standard inner and outer covers on the honey super and a cover for the non-multistory part of the hive body (both an inner insulating cover [fitting on the top underneath an outer cover] and an outer cover [last cover to fit over the super to protect it from rain], which includes migratory outer cover [without going over the sides of the hive on one side], which must be modified to fit on half of the hive body—see Figures). In one embodiment, the hive body has a separate single lid the length of the hive body for use in different situations without a super.

As used herein, the novel “frame for use in a beehive” is a frame for use next to a viewing window. Unlike standard commercial beehive frames, the top bar is longer than the bottom bar (as seen in the drawings), the uprights of the rectangular frame are equal in size, thus allowing for creating of an open space in front of the window to aid in viewing bee activity. The foundation is positioned only between the two end bars. The bees will draw out comb on the unsupported portion of the frame.

The advantage of the construction of the present invention hive system is that it produces more honey than a standard top bar hive construction, while being more environmentally friendly than other multistory arrangements and is easier to manipulate.

Now referring to the drawings, FIG. 1 is a perspective view of the hive system of the present invention. In this view, hive system 1 consists of a hive body 2 sitting on the lengths 15 of a pair of side-by-side beehive bottom boards 3a and 3b, which in turn rest upon frame 4. Each of the bottom boards 3a and 3b have an entrance reducer 6 positioned on the front 8 of the bottom boards 3a and 3b. A honey super 10 sits on one half of the hive body 2 positioned essentially over just one of the bottom boards 3b. At the same time, the other half of the hive body 2 only has cover 11 on it, designed for only sitting on half of the hive body 2. The honey super 10 also has a cover 12 of the standard outer cover type that would sit on the honey super. In one embodiment, not shown, multiple supers can be stacked on top of the shown super, but are left out for simplicity's sake, since such an arrangement is well known and shown in the art cited by applicant, which is incorporated by reference.

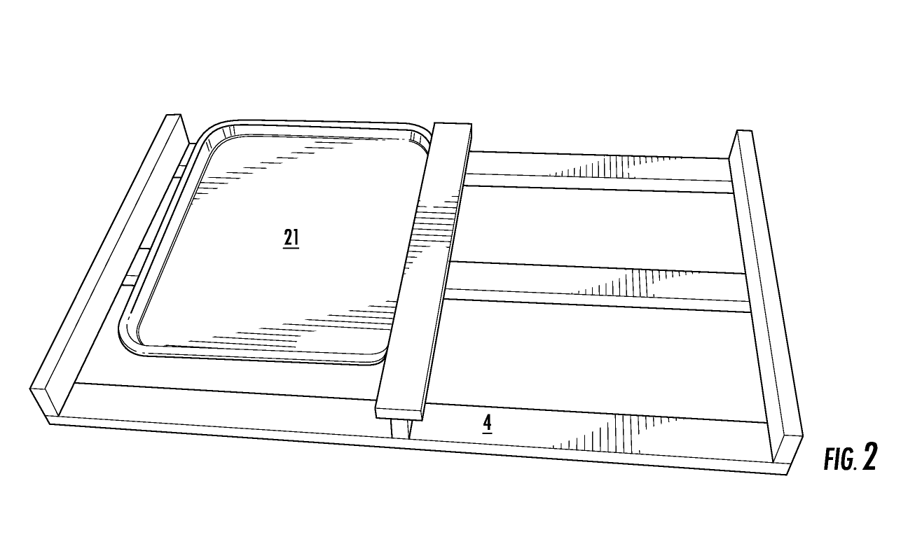

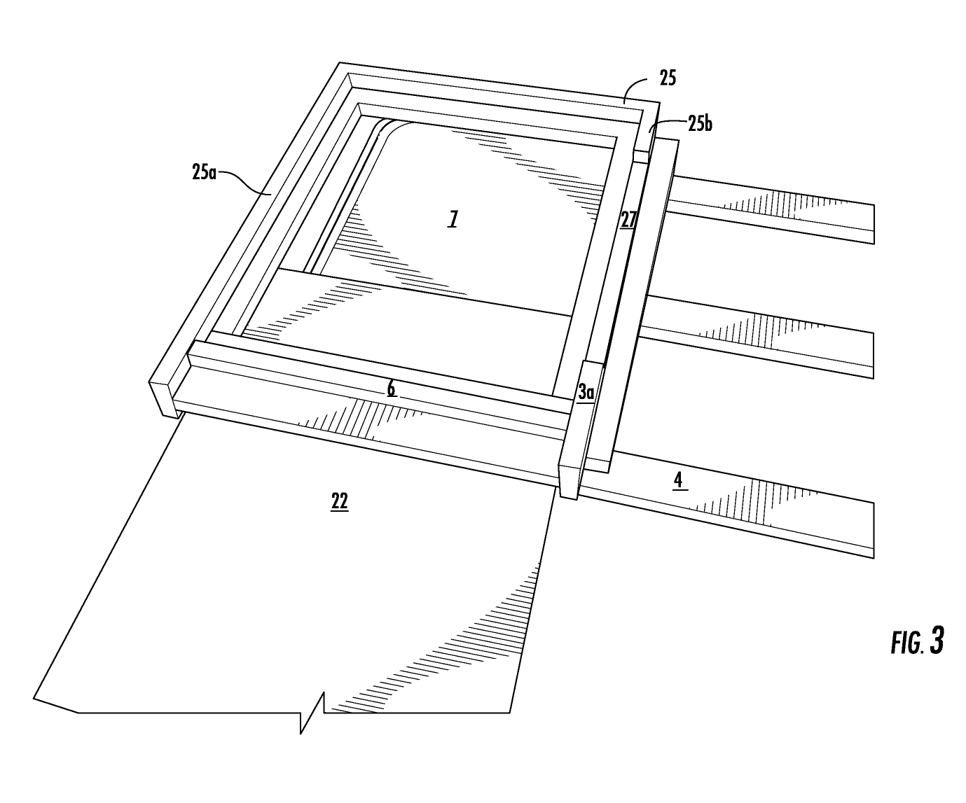

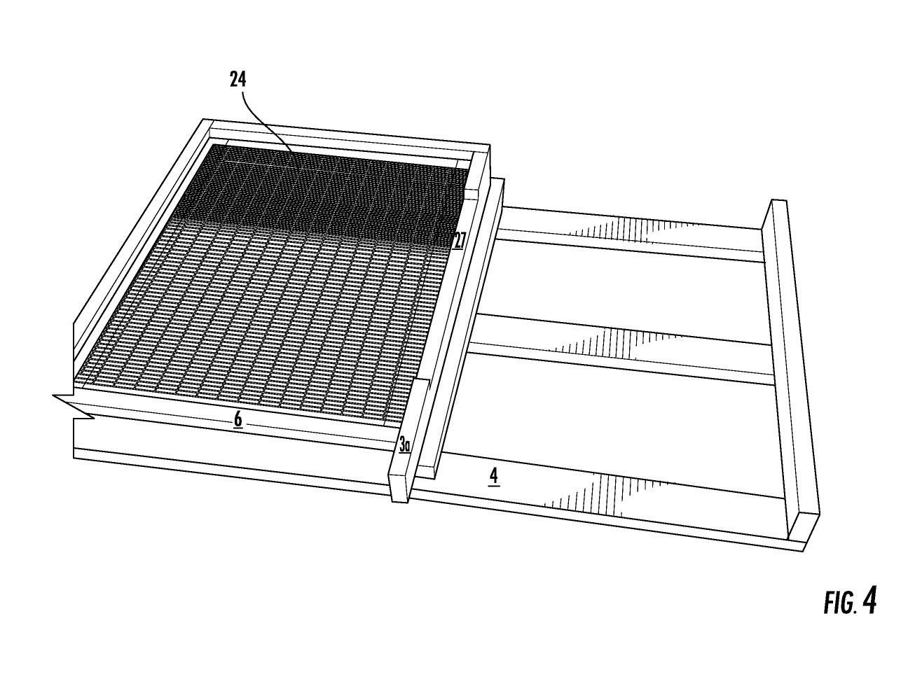

FIG. 2 depicts a perspective of frame 4 having a debris catcher 21, positioned under where one of the bottom boards is positioned in the frame 4. FIG. 3 shows the bottom board 3a positioned on the frame with a standard beehive flat board 22 being inserted underneath the bottom board 3a. In this view, one can see the bottom board's raised sides 25a and 25b, and first width side 25. Length 25a has the same height as back width 25. Length 25b has the same height as side 25a, however a portion of the side 27 is lower in height for allowing bees to cross. FIG. 4 shows that a queen bee excluder 24 can also be positioned on the bottom board 3a.

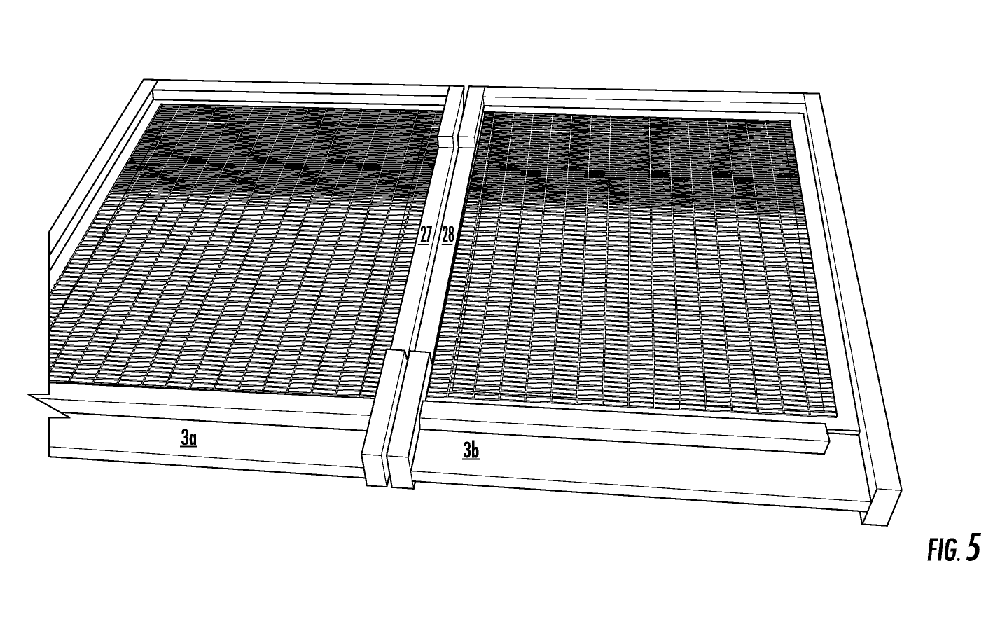

In FIG. 5 there is a second bottom board 3b positioned side by side with bottom board 3a. It is identical to bottom board 3a, except bottom board 3b has lower height 28 positioned on the length opposite bottom board 3a, so that as the two bottom boards are side by side, lower heights 27 and 28 are positioned next to one another allowing a bee to cross between the bottom boards when a hive body is sitting on the higher edges. The bottom boards are standard bottom boards except for the lower side portions 27 and 28, which means heights are standardized and that these bottom boards could be utilized with standard bottom boards. In other words, the heights of the sides representing the length and width are within the skill in the art except for the lower portion on the lengths, since prior to the present invention two bottom boards were never placed next to one another by their lengths.

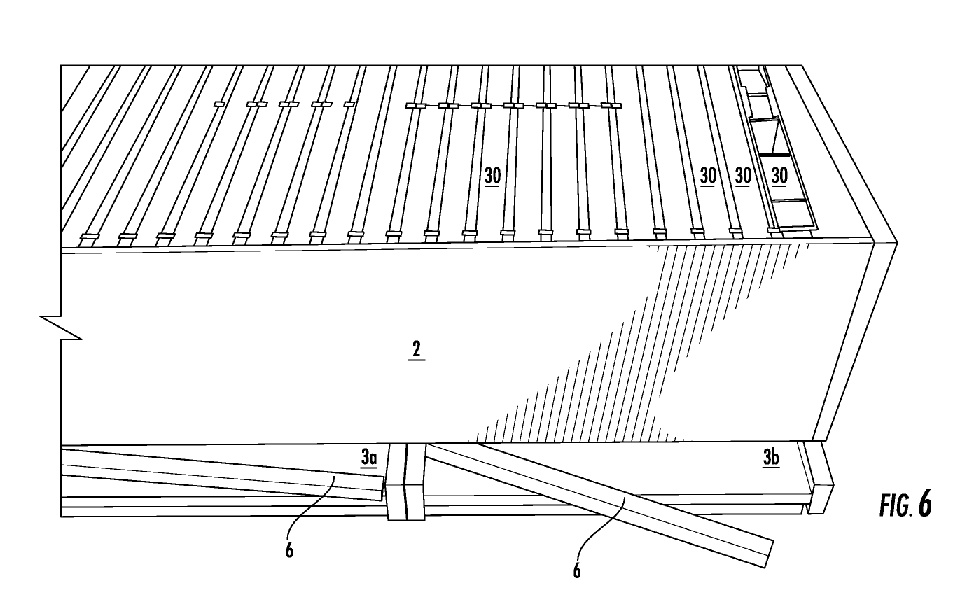

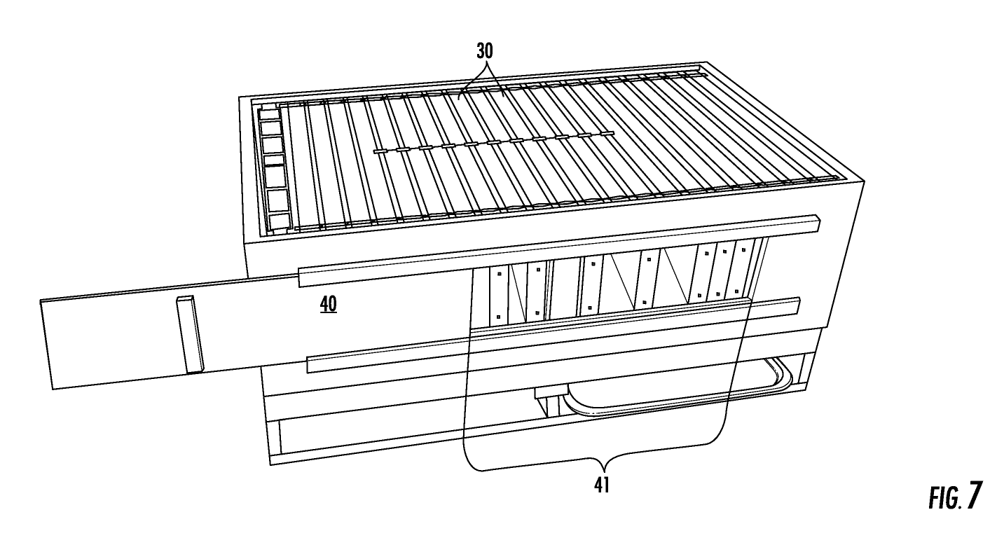

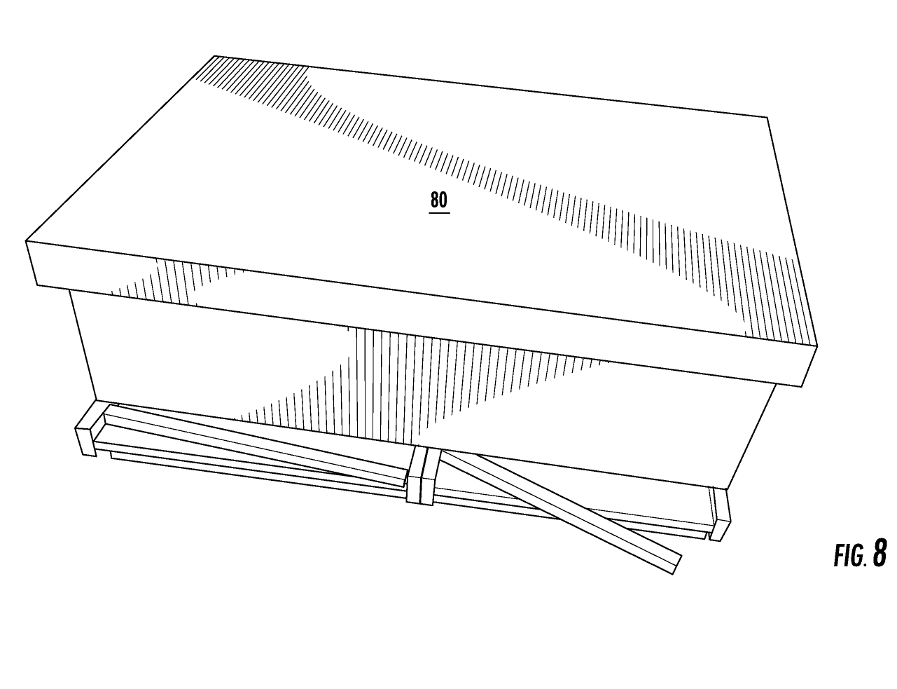

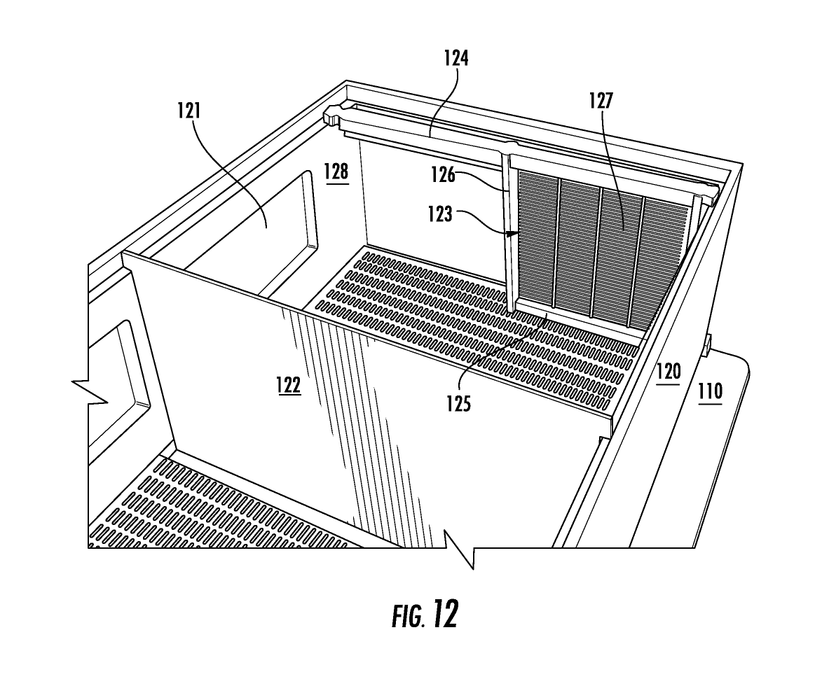

FIG. 6 is a perspective view of the hive body 2 sitting on the bottom boards 3a and 3b with no covers or supers on the hive body 2. In this view one can see the plurality of standard hive frames 30 (not the novel ones), since normally two ten-frame hive bodies can only hold twenty frames, the hive body of the present invention is different, holding twenty frames (plus an extra one or two frames) due to the space created by the lack of walls. This is a hive body not previously utilized or suggested due to the standardization of beehive components. FIG. 7 is a perspective view of the back of the hive body shown in FIG. 6 showing the sliding view door 40 on the back side of hive body 2 which reveals access opening 41 which allows access to view the frames 30 without removing a top on the hive body 2. These can be replaced with the frame of FIG. 12 for better viewing of the inside of the hive. FIG. 8 shows a perspective view of cover 80 which covers the length of the hive body 2. It should be noted that the hive body 2 could, in one embodiment, be longer than the width of two bottom boards, thus allowing even more frames to be utilized.

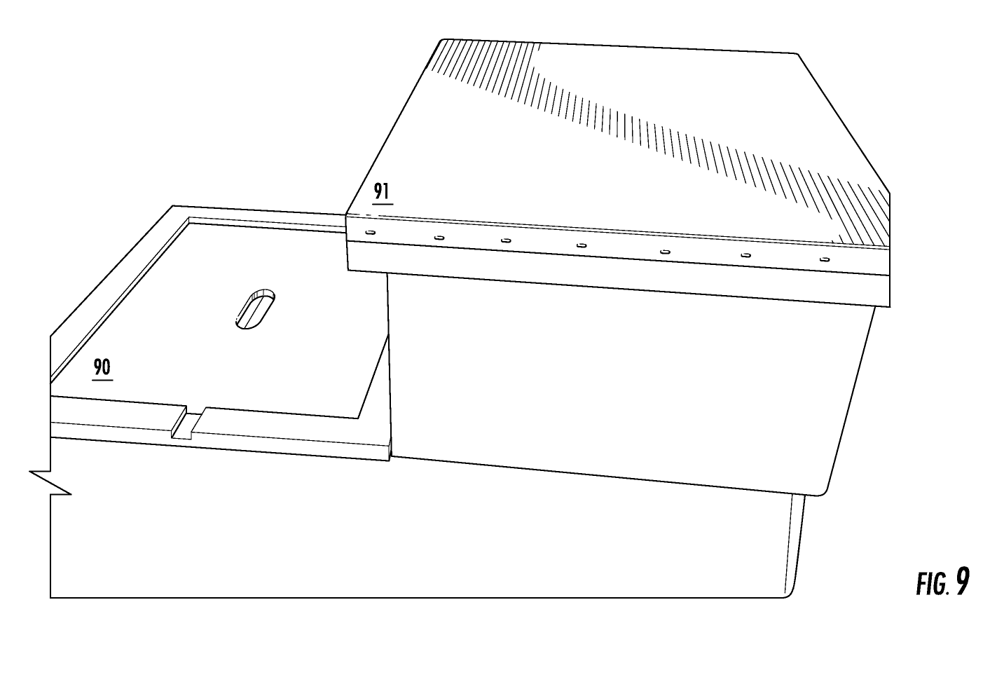

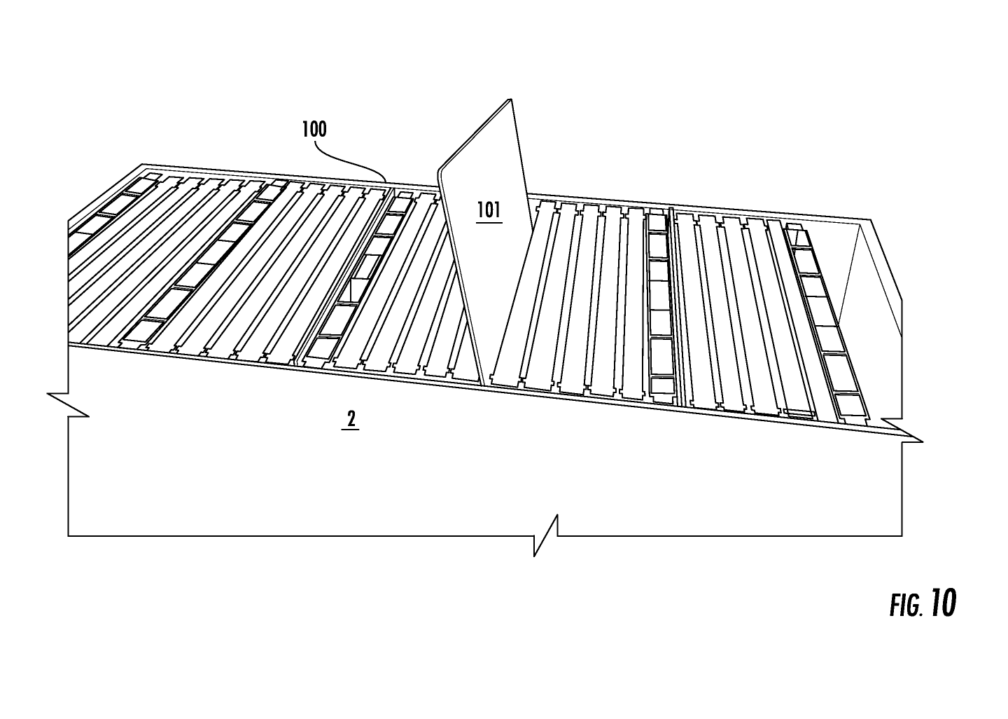

FIG. 9 is a perspective view showing that the covers of the invention can include an inner cover 90 and regular outer cover 91 on both the hive body and super interchangeably. FIG. 10 shows an extra-long hive body 100 having dividers 101 allowing the hive body to act like separate hive bodies in the single hive body.

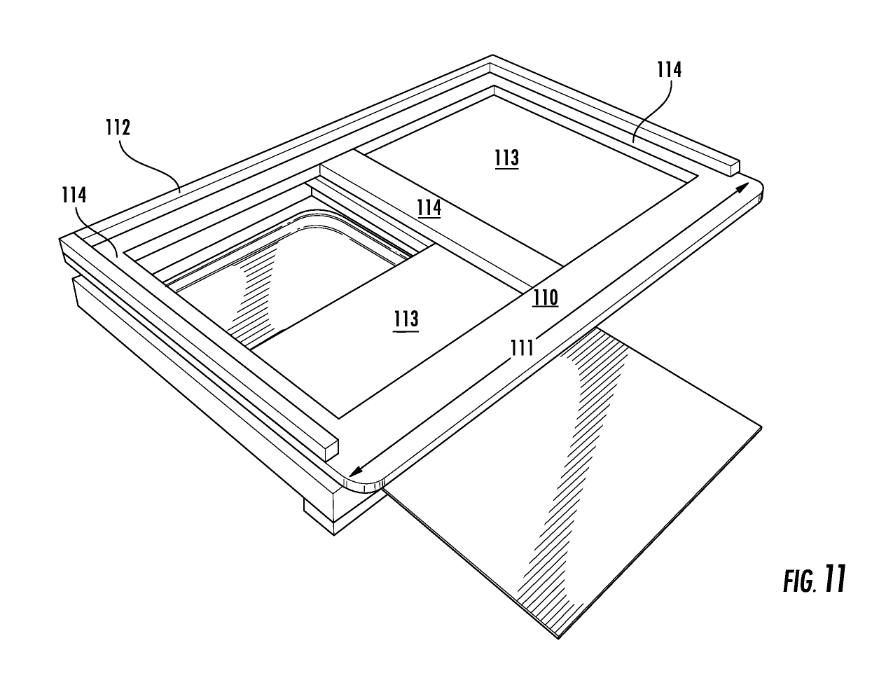

In one embodiment, instead of two side by side bottom boards as shown in FIG. 3, the single bottom board can be substituted with all else from the same. In FIG. 11 a double wide bottom board 110 is shown, which is about the width 111 of two standard bottom boards. It has raised edges 112 and two flat boards 113. When a hive body is placed on the raised edges 112 bees can access the interior bottom area 114 of the bottom board. This board can be utilized in FIG. 3, substituting for the side by side bottom boards.

FIG. 12 shows a hive body 120 on top of a bottom board 110 of the type in FIG. 11. In this view, a viewing window 121 is seen on the back wall of the hive body 120. Removable divider board 122 can be utilized to divide the hive into multiple hives. In this view novel hive frame 123 is shown. It has a top bar 124 that spans the depth of the hive body 120. Bottom bar 125 is shorter and a rectangle is formed with uprights 126 containing honeycomb 127. The space between uprights 126 and wall 128 create a viewing space to view bee activity through viewing window 121.

What is claimed is:

1. A beehive system comprising:
a) a pair of frame rectangular beehive bottom boards each having the same length and width as each other, the bottom boards having raised sides along their lengths and a first width, the bottom boards positioned side by side along their lengths wherein the side by side lengths have at least a portion of their height lower than the height of the opposite sides of each bottom board such that a bee can travel between bottom boards when a hive body is positioned thereon, and wherein each bottom board has a bee entrance on a second width facing the same direction;
b) a rectangular hive body having perpendicular sides relative to a bottom and having a length adapted to fit the width of the side by side bottom boards, the hive body positioned on the pair of bottom boards across the two widths, the hive body adapted to receive rectangular beehive frames;
c) a honey super positioned over the hive body and over one of the bottom boards;
d) an outer cover to fit the top of the honey super; and
e) a migratory cover to fit the top of the hive body over the portion of the hive body not covered by a honey super.

2. The beehive system according to claim 1 wherein the hive body has a plurality of beehive frames positioned therein.

3. The beehive system according to claim 1 wherein the beehive super has a height about the same as the hive body.

4. The beehive system according to claim 1 wherein there is an entrance reducer positioned in each of the second width of the bottom boards.

5. The beehive system according to claim 1 wherein there is a sliding opening on a back wall of the hive body.

6. The beehive system according to claim 1 wherein the system sits on a raised frame.

7. The beehive system according to claim 1 wherein there is a beehive flat board positioned in each beehive bottom board.

8. A rectangular hive body of a size having perpendicular sides relative to a bottom and having a length adapted to fit on at least the width of two side by side frame beehive bottom boards.

9. The hive body according to claim 8 which has a lid positioned on the length of the top of the beehive.

10. The hive body according to claim 8 wherein the hive body has moveable dividers separating the hive body into separate beehives.

11. A frame rectangular beehive bottom board, the bottom board having raised sides along its lengths and a first width, and having at least a portion of one of the long sides lower than the height of the opposite side of the bottom board, such that a bee can travel between the bottom boards and the bottom of a hive body when a hive body is positioned thereon.

12. A pair of bottom boards according to claim 11 wherein the lower height side of the bottom board is on a different length on each of the two bottom boards.

13. A beehive system comprising:
a) a frame honey super having a first length and a first width;
b) a beehive bottom board having a second width larger than the honey super first width wherein bees can travel the entire widths of the bottom boards;
c) a hive body the width and length of the beehive bottom board having perpendicular sides adapted to receive rectangular beehive frames the body position on the bottom board; and
d) wherein the honey super is positioned on a portion of the hive body and wherein the bottom board has a bee entrance.

14. The hive system according to claim 13 wherein the bottom board width is about twice the honey super first width.

15. The beehive system according to claim 13 wherein there is a hive body divider separating the hive body into multiple rectangular hives.

16. A frame for use in a beehive accepting rectangular frames comprising a top bar, two upright side bars, and a bottom bar wherein the top bar is longer than the bottom bar.

17. The frame according to claim 16 wherein there is honeycomb mounted in the frame between the two upright bars.

18. A beehive bottom board for use with a beehive super by a first width and first length comprising the bottom board the same length as the super and having a width wider than the super by at least about 10%, wherein bees can travel essentially the entire width of a bottom of the bottom board.

19. The bottom board according to claim 18 wherein the width is about twice the super first width.

20. A beehive system according to claim 1 or 13 wherein there are frames positioned therein which are coded to indicate at least one of contents, function, or manipulations.

21. A beehive system according to claim 20 wherein the coding is a color coding.
